(19) United States
(12) Patent Application Publication
(10) Pub. No.: US 2006/0045703 A1
(43) Pub. Date: Mar. 2, 2006

(54) Loading assembly with automatic latch and method

(76) Inventor: Michael Dougherty, St. Clair Shores, MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 10/913,935

(22) Filed: Aug. 6, 2004

(51) Int. Cl. B60P 1/00

(52) U.S. Cl. 414/537

(57) ABSTRACT

A loading assembly includes an elongated rod connected to a load bearing structure. A ramp is selectively movable toward and away from the rod for attaching and detaching, respectively, with respect to the load bearing structure. A latch is connected to the ramp and movable between a first position and a second position with respect to the ramp. The latch automatically moves from the first position to the second position to trap the rod between the latch and the ramp when the ramp is moved toward the rod and the latch contacts the rod, thereby attaching the ramp with respect to the load-bearing structure. The latch automatically moves from the second position to the first position to release the rod from between the latch and the ramp when the ramp is moved away from the rod, thereby detaching the ramp with respect to the load bearing structure.

### TECHNICAL FIELD

This invention relates to loading assemblies having a ramp that automatically latches and releases with respect to a load bearing structure, such as a vehicle tailgate.

### BACKGROUND OF THE INVENTION

Ramps have long been used to assist in transferring (i.e., loading) items from one elevation to another elevation. For instance, simple wooden planks may be laid across steps in order to move items up or down the steps. With respect to vehicles, a variety of original and after-market equipment has been devised to assist in loading and unloading items from a cargo space in a vehicle. For instance, with respect to a pickup truck, ramps designed to be permanently integrated with the tailgate are known. Loading assemblies (i.e., ramps and their associated attachment mechanisms) that are easily and securely positioned for loading are desired.

### SUMMARY OF THE INVENTION

A loading assembly is provided that includes a ramp easily and securely latchable to a load-bearing structure. The loading assembly includes an elongated rod connected to a load-bearing structure. The loading assembly further includes a ramp selectively moveable toward and away from the rod for attaching and detaching, respectively, with respect to the load-bearing structure. A latch is connected to the ramp and movable between a first position and a second position with respect to the ramp. The latch automatically moves from the first position to the second position to trap the rod between the latch and the ramp when the ramp is moved toward the rod and the latch contacts the rod, thereby attaching the ramp with respect to the load bearing structure. The latch automatically moves from the second position to the first position to release the rod from between the latch and the ramp when the ramp is moved away (i.e., lifted) from the rod, thereby detaching the ramp with respect to the load bearing structure. Thus, simply moving the ramp toward the rod so that the latch contacts the rod causes attachment of the ramp to the load bearing structure permitting loading via the ramp. Similarly, simply moving the ramp away from the rod automatically detaches the ramp from the load-bearing structure.

In one aspect of the invention, a pivot pin is disposable between the latch and the ramp for pivotably connecting the latch and the ramp with one another.

In another aspect of the invention, the latch includes a first portion and a second portion. The first and second portions are angularly displaced from one another about the pivot pin such that the first portion contacts the rod causing the latch to pivot about the pivot pin to trap the rod between the second portion and the ramp when the ramp is moved toward the rod.

In another aspect of the invention, a spring element is connected to the latch. The latch is biased toward the first position by the spring element. The spring element acts to pivot the latch from the second position to the first position when the ramp is moved away from the rod. Thus, the spring element causes the automatic “unlocking” of the latch from the rod when the ramp is moved away (e.g., lifted away) from the rod.

In another aspect of the invention, the load-bearing structure is a vehicle that includes a tailgate and a floor. The tailgate and the floor at least partially define a cargo bed. The rod is connectable to the tailgate.

In another aspect of the invention, the tailgate is formed with a recessed portion. The rod includes two end portions and a mid portion between the end portions. The rod is pivotably mountable to the tailgate at the two end portions. The rod is pivotable between a non-loading position, in which the rod is substantially within the recess, and a loading position, in which the mid portion extends sufficiently from the tailgate such that the tailgate and the mid portion form a gap therebetween. The latch is disposable within the gap such that the rod is trapped between the latch and the ramp when the ramp is moved toward the rod. Thus, the rod is shaped with a mid portion between two end portions that forms a gap with the tailgate for receiving the latch to allow the rod to be trapped between the latch and the ramp, thereby attaching the ramp with respect to the tailgate.

In another aspect of the invention, the rod at least partially restrains movement of the ramp between the two end portions when the latch is disposed within the gap. Specifically, the end portions help restrain movement of the ramp transversely with respect to the tailgate. Thus, the ramp may not slide sideways beyond either of the end portions, enhancing the stability of the ramp during loading.

In another aspect of the invention, the ramp is extendable between the load-bearing structure and a support surface. The ramp includes a first end and an opposite second end. The latch (i.e., a first latch) is connected to the ramp at the first end. The loading assembly further includes another latch (i.e., a second latch) that is substantially identical functionally and structurally with the first latch. The second latch is connected to the ramp at the second end. The first or second end of the ramp is selectively moveable toward the rod such that the first latch or the second latch, respectively, attaches the ramp with respect to the load-bearing structure and the other of the latches extends between the ramp and the support surface, thereby effectively extending the length of the ramp. In short, one of the latches is used to connect the ramp with respect to the tailgate and the other of the latches is used to extend between the ramp and a support surface (i.e., at the other end of the ramp) to effectively extend the length of the ramp to ease loading of items from the support surface to the cargo bed.

A vehicle includes a floor and a tailgate pivotable between a substantially perpendicular and a substantially coplanar position with respect to the floor. The floor and the tailgate are configured to at least partially define a cargo space. The vehicle further includes a rod connected to the tailgate. A ramp is configured for loading the cargo space. A latch is connected to the ramp and pivotable between a first position and a second position with respect to the ramp. A spring element (i.e., a first spring element) is connected to the latch. The first spring element biases the latch toward the first position. The ramp is selectively moveable toward and away from the rod. The latch is configured to contact the rod when the ramp is moved toward the rod and the tailgate is in the substantially coplanar position. The latch pivots from the first position to the second position to trap the rod between the latch and the ramp, thereby attaching the ramp with respect to the tailgate to permit loading of the cargo space. The first spring element causes the latch to pivot from the second position to the first position when the ramp is moved away from the tailgate, thereby releasing the rod from the latch to detach the ramp with respect to the tailgate.

In another aspect of the invention, the vehicle rests on a support surface. The ramp has a first end and an opposing second end. The latch (i.e., the first latch) is connected to the ramp at the first end and traps and releases the rod when the first end is moved toward and away from the rod, respectively. The vehicle further includes another latch (i.e., a second latch) connected to the ramp at the second end. The vehicle further includes another spring element (i.e., a second spring element) connected to the second latch. The second latch and the second spring element function identically as the first latch and the first spring element, respectively, such that the second latch traps and releases the rod when the second end is moved toward the rod and the first latch contacts the rod, and is moved away from the rod, respectively. The first latch and the second latch are each configured to extend between the ramp and the support surface, thereby effectively extending the ramp, when the other of the first latch and the second latch, respectively, traps the rod.

In another aspect of the invention, the ramp is configured with a generally elongated planar shape. The floor is characterized by a first length. The ramp and the connected latches together are characterized by a second length that is shorter than the first length of said floor such that said ramp with the connected latches fits within the cargo space for storage when the ramp is detached with respect to the tailgate and the tailgate is in the substantially perpendicular position.

In another aspect of the invention, the vehicle includes an additional ramp configured for loading the cargo space. An additional latch is connected to the additional ramp. An additional spring element is connected to the additional latch. The additional ramp, latch and spring element are substantially identical functionally and structurally with the first ramp, the first latch and the first spring element, respectively, such that both ramps are attachable with respect to said tailgate via the respective latches trapping the rod between the respective latches and the respective ramps to permit loading of said cargo space via both of the ramps.

A method includes pivoting a tailgate connected to a floor of a vehicle from a closed position, in which the tailgate is substantially perpendicular to the floor (the tailgate and the floor at least partially defining a cargo space in the closed position), to an open position, in which the tailgate is substantially coplanar with respect to the floor for loading the cargo space.

The method further includes moving a ramp toward a rod connected to the tailgate. The method further includes contacting a latch attached to the ramp with the rod, thereby at least partially supporting the ramp by the rod, and causing automatic movement of the latch from a first position to a second position to trap the rod between the latch and the ramp to attach the ramp with respect to the tailgate.

In another aspect of the invention, the method further includes moving the ramp away from the rod, thereby causing the latch to come out of contact with the rod and causing automatic movement of the latch from the second position to the first position to release the rod from between the latch and the ramp to detach the ramp with respect to the tailgate.

In another aspect of the invention, the method further includes storing the ramp in the cargo space. The method may further include pivoting the tailgate from the open position to the closed position to contain the ramp within the cargo space.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective illustration of a loading assembly including two ramps shown in an exploded or detached position with respect to a rod extending from a tailgate of a vehicle;

FIG. 2 is a schematic perspective fragmentary view of a phantom portion of the tailgate of FIG. 1, with topside views of one of the ramps attached to the rod via a latch and the other of the ramps positioned for attachment to the rod;

FIG. 3 is a schematic perspective fragmentary view of the bottom side or opposite side of the attached ramp of FIG. 2, with the phantom tailgate portion removed and including the latch; and

FIG. 4 is a flow diagram of a method of attaching and detaching a ramp to a tailgate.

### DESCRIPTION OF THE PREFERRED EMBODIMENT

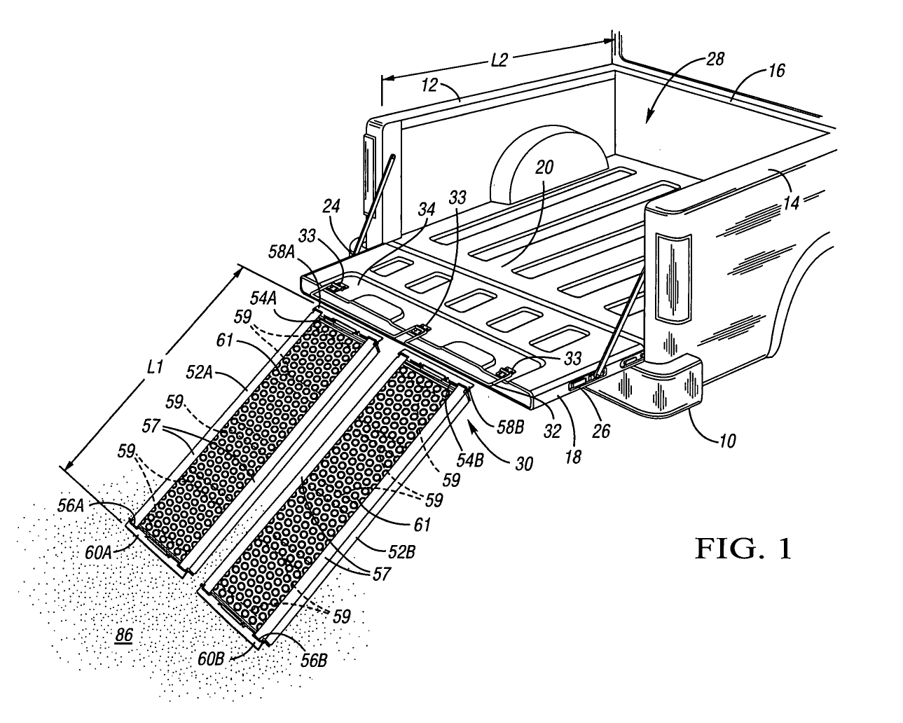

Referring to the drawings, wherein like reference numbers refer to like components, FIG. 1 illustrates the cargo portion of a vehicle 10. The vehicle 10 includes a left sidewall 12, a right sidewall 14, a front wall or midgate 16 and a tailgate 18. The vehicle 10 further includes a floor 20. The tailgate 18 is pivotable with respect to the floor 20 between an open position (shown) in which the tailgate 18 is substantially coplanar with respect to the floor 20, and a closed position (not shown) in which the tailgate 18 is upright or substantially perpendicular with respect to the floor 20, and in which sides 24, 26 of the tailgate 18 are adjacent to the rear ends of the left sidewall 12 and the right sidewall 14, respectively, of the vehicle 10. When the tailgate 18 is in the closed or upright position, the tailgate 18, the left and right sidewalls 12, 14 and the midgate 16 along with the floor 20 define a cargo space 28. The vehicle 10 may also be referred to as a load bearing structure, as it is designed to support and transport loads (i.e., cargo such as 3-wheeled and 4-wheeled all terrain vehicles, snowmobiles, construction equipment, etc.) in the cargo space 28.

FIG. 1 further illustrates a loading assembly 30. The loading assembly 30 includes an elongated rod 32 (shown in a loading position) that is connected to the tailgate 18 via three ramp hanger retainers 33 (also referred to as mounting brackets) that are screwed or otherwise affixed to the tailgate 18. Preferably, the rod 32 is 3/16 inch diameter steel rod. Notably, the tailgate 18 is formed with a recessed portion 34.

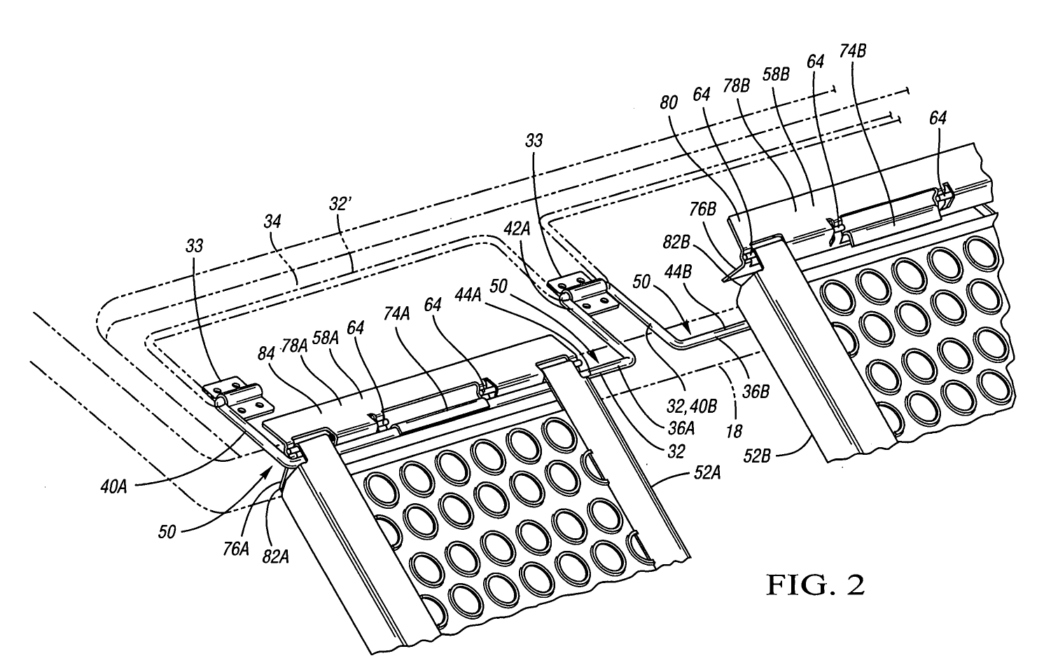

Referring to FIG. 2, it is more easily seen that the rod 32 is formed or configured with two sections, a first section 36A and a second section 36B. The two sections 36A and 36B may be continuous (i.e., connected as in an integral rod) or separate. In the embodiment shown in FIG. 2, the rod 32 is continuous. Referring to the first section 36A, the first section is shaped or configured to form two end portions, a first end portion 40A and a second end portion 42A, and a midportion 44A located between the end portions 40A and 42A.

In an embodiment in which the two sections 36A and 36B of the rod 32 are separate, respective ends of each section 36A, 36B would be trapped under the middle bracket 33. The other respective end of each section 36A and 36B would connect under the respective outer bracket 33 (i.e., the bracket 33 located closest to the respective side 24 or 26 of the tailgate 18) from the inboard side of the bracket (rather from the outboard side as shown in FIG. 2). For instance, in FIG. 2, the first end portion 40A of the first section 36A would be modified so that it would extend under the outer bracket 33 from an inboard side of the outer bracket 33. This would prevent the section 36A from slipping sideways out from underneath the brackets 33. The outer end portion of the second section 36B would be similarly modified.

When the tailgate 18 is in the open position, the rod 32 is pivotable with respect to the tailgate between the loading position and a non-loading position (shown in phantom as 32′). In the nonloading position, the rod 32′ is stored substantially within the recess 34 formed in the tailgate 18. When the rod 32 is in the loading position, the midportion 44A of the first section 36A of the rod extends outward from the tailgate 18 such that the tailgate 18 and the midportion 36A form a gap 50 therebetween. The second section 36B of the rod likewise includes end portions (only end portion 40B being shown in FIG. 2 but a like end portion in a mirror image to end portion 40B also being included as seen in FIG. 1) as well as a midportion 44B disposed therebetween.

Referring again to FIG. 1, the loading assembly 30 further includes a pair of ramps 52A and 52B. Each of the ramps 52A, 52B is formed with a first end 54A, 54B, respectively, and a second end 56A, 56B, respectively. Preferably, the ramps 52A, 52B are formed from 2 inch×2 inch×⅛ inch×12 inch angle iron braces 59 running transversely, 2 inch×2 inch×⅛ inch×6 foot angle iron stiles 57 running lengthwise, and a plank 61, preferably formed from OPEN-GRIP™ Grating manufactured by Morton Manufacturing Company. With this construction, each of the ramps should have a weight of 25 pounds or less, thus making the ramps easy to handle while providing adequate strength for supporting heavy loads. Other suitable materials may also be used to form the ramps 52A, 52B within the scope of the invention.

With reference to FIG. 1, the loading assembly 30 further includes first latches 58A, 58B (latch 58B also being referred to herein as an “additional” latch) and second latches 60A, 60B (also referred to herein as “another” latch) disposed at the first and second ends 54A, 54B and second ends 56A, 56B of the ramps 52A, 52B, respectively. Preferably, the latches 58A, 58B, 60A, 60B are formed from 2 inch×2 inch×⅛ inch×12 inch angle iron, although other suitable materials may be employed within the scope of the invention. Notably, each of the ramps 52A, 52B including the connected latches 58A, 58B and 60A, 60B, is characterized by a length L₁ that is less than a length L₂ of the floor 20 such that the ramps 52A and 52B with attached respective latches are configured to fit within the cargo space 28 when the tailgate 18 is placed in the closed (i.e., upright or vertical) position. Thus, the ramps 52A, 52B with attached latches 58A, 58B, 60A, 60B are configured for storage and transport in the cargo space 28 of the vehicle 10. Notably, the loading assembly 30 may be a new vehicle option, or may be an after-market purchase, requiring the attachment of the rod 32 to the tailgate 18 but no other modifications to the vehicle 10.

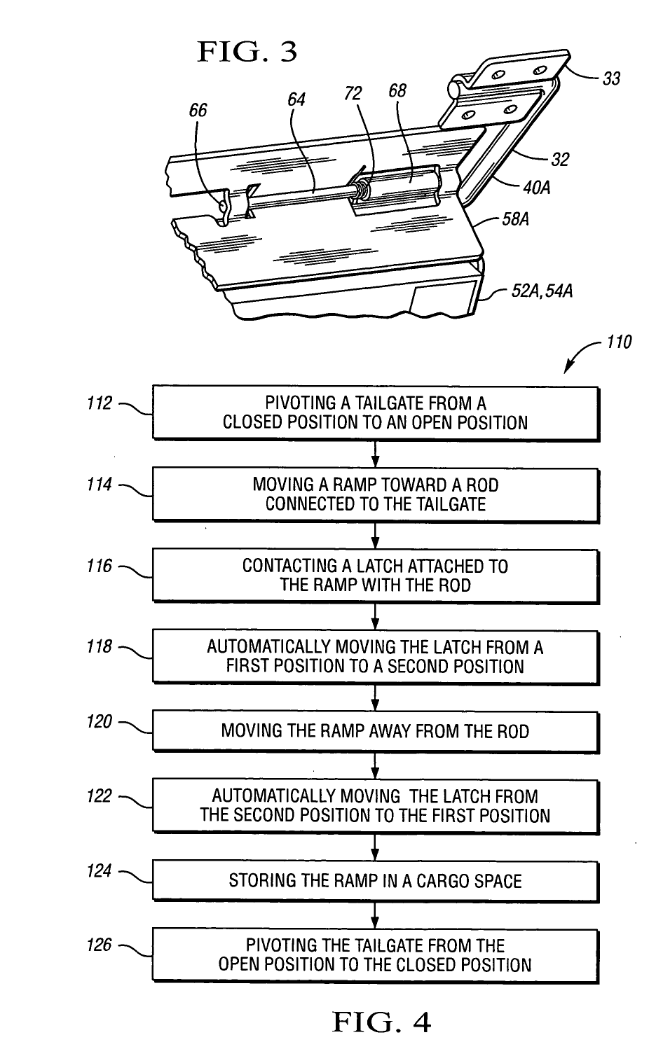

Referring now to FIG. 3, a more detailed view of a portion of the latch 58A at the first end 54A of the ramp 52A is shown. Only a portion of the latch 58A adjacent to the first end portion 40A of the rod 32 is shown. The latch 58A includes a pivot pin 64 fixedly welded or mounted to the latch near one end 66 and pivotably retained within a pin retaining portion 68 of the ramp 52A at another end. The latch 58A further includes a spring element 72, which may be a torsion or circular spring disposed about the pivot pin 64.

Referring again to FIG. 2, each of the latches 58A, 58B at the first ends 54A, 54B of the ramps 52A, 52B includes two pivot pins 64. Each of the pivot pins 64 includes a spring element 72 (FIG. 3). Furthermore, the latches 60A, 60B at the second ends 56A, 56B of the ramps 52A, 52B are mirror images of the latches 58A, 58B at the first ends, also each including two pivot pins, each pivot pin having a spring element.

Referring to the ramp 52B in FIG. 2, the latch 58B includes a first portion 74B and a second portion 76B. The first and second portions 74B, 76B are angularly displaced from one another about the pivot pin 64. The latch 58B further includes a support portion 78B that is also angularly displaced with respect to the first and second portions 74B, 76B of the latch 58B. A corresponding first portion 74A and second portion 76A as well as a support portion 78A are shown on the latch 58A of ramp 52A. The latches 60A and 60B at the second ends 56A and 56B of the ramps 52A and 52B, respectively, shown in FIG. 1 are configured identically to the latches 58A and 58B shown in FIG. 2.

The spring element 72 (shown in FIG. 3) is used on each of the latches 58A, 58B, 60A and 60B to bias these latches toward a first position 80 (shown with respect to the latch 58B in FIG. 2). When the latch 58B is in the first position 80, the second portion 76B of the latch is not in contact with an upper edge 82B of the ramp 52B.

When the ramp 52B is moved towards the rod 32 (i.e., manually moved) guiding the second portion 76B of the latch 58B into the gap 50, the ramp 52B is lowered such that the midportion 44B of the second section 36B of the rod 32 is disposed between the second portion 76B of the latch 58B and the upper edge 82B of the ramp 52B. If the ramp 52B is lowered further, the latch 58B is designed such that the first portion of the latch 74B will first come into contact with the midportion 44B of the rod 32. When the first portion 74B contacts the midportion 44B, the lowering weight of the ramp 52B causes the latch 58B to pivot about the pivot pin 64, overcoming the force of the spring element 72 biasing the latch 58B toward the first position 80, such that the latch 58B automatically pivots to a second, closed position (shown with respect to the latch 58A) in which the midportion 44B of the rod 32 is trapped between the second portion 76B of the latch 58B and the upper edge 82B of the ramp 52B.

The closed position of the latch about the trapped rod is better viewed with respect to the ramp 52A. In the closed position 84, the first portion 74A of the latch 58A is in contact with the midportion 44A of the rod 32. Furthermore, the support portion 78A of the latch 58A rests upon the tailgate 18 (shown in phantom). The second portion 76A of the latch 58A is disposed within the gap 50 formed between the tailgate 18 and the rod 32 and abuts the upper edge 82A of the ramp 52A such that the midportion 44A of the rod 32 is trapped between the latch 58A and the ramp 52A. Notably, when the second portion 76A of the latch 58A is trapped between the rod 32 and the tailgate 18, the curved formation of the rod (i.e., the curve formed by the midportion 44B with respect to the end portions 40A, 42A) permits the ramp 52A to be restrained between the two end portions 40A, 42A of the first section 36A of the rod 32. Likewise, the ramp 52B will be restrained by the curve formed by the midportion 44B and its respective end portions (only end portion 40B shown in FIG. 2 but both end portions being visible in FIG. 1). Thus, the ramps 52A and 52B are prevented from sliding sideways off of the rod 32, and are stabilized with respect to the tailgate 18. Each of the ramps 52A, 52B may be attached to the vehicle 10 by either of latches 58A or 60A and 58B or 60B, respectively. This is convenient for the operator, who may always choose the end closest to the vehicle 10 for attachment.

To detach the ramps 52A and 52B from the tailgate 18, the ramps are simply lifted upward. Referring to the ramp 52A of FIG. 2, upward lifting of the ramp 52A will cause the first portion 74A of the latch 58A to move out of contact with the rod 32. When this happens, the weight of the ramp 52A is no longer overcoming the biasing force of the spring element 72 (shown in FIG. 3) acting on the latch 58A; accordingly, the latch 58A automatically moves from the second position to the first (open) position (similar to that shown with respect to latch 58B). When the latch 58A is in the open position, the second portion 76A of the latch 58A may be lifted out of the gap 50 and the first section 36A of the rod 32 is thereby no longer trapped between the second portion 76A of the latch and the upper edge 82A of the ramp 52A. Once removed from the rod 32, the ramps 52A and 52B may be stored within the cargo space 28 of the vehicle 10 shown in FIG. 1. The rod 32 may be pivoted back to the non-loading position (shown as 32′), and the tailgate 18 returned to an upright position (not shown).

Referring again to FIG. 1, the latches 60A and 60B of the ramps 52A and 52B rest on a support surface 86 (e.g., the ground). The latches 60A and 60B are in the first (open) position (as shown with respect to the latch 58B in FIG. 2). Referring to FIG. 2, it may be seen that in the open position 80, the support portion 78B of the latch 58B is generally coplanar with the ramp 52B due to the spring bias on the latch. Accordingly, the latches 60A and 60B resting on the support surface 86 extend between the ramps 52A, 52B, respectively, and the support surface 86 thereby effectively extending the loading length of the ramps 52A and 52B. The latches 60A and 60B disposed at the second ends 56A and 56B of the ramps 52A and 52B, respectively, thus serve as pre-loading extensions to facilitate loading of objects from the support surface 86 up the ramps 52A, 52B to the cargo space 28.

Referring to FIG. 4, a method of attaching a ramp to a vehicle 110 includes pivoting a tailgate 112 from a closed position to an open position. The method 110 further includes moving a ramp toward a rod 114 connected to the tailgate. The method 110 further includes contacting 116 a latch attached to the ramp with the rod. The method 110 may further include automatically moving the latch from a first position to a second position 118 to trap the rod between the latch and the ramp to attach the ramp with respect to the tailgate. The method 110 may further include moving the ramp away from the rod 120. The method 110 may further include automatically moving the latch from the second position to the first position 122 to release the rod from between the latch and the ramp to detach the ramp with respect to the tailgate. The method 110 may further include storing 124 the ramp in the cargo space. The method 110 may further include pivoting the tailgate from the open position to the closed position 126.

While the best mode for carrying out the invention has been described in detail, those familiar with the art to which this invention relates will recognize various alternative designs and embodiments for practicing the invention within the scope of the appended claims.

1. A loading assembly comprising:
an elongated rod connected to a load-bearing structure;
a ramp selectively movable toward and away from said rod for attaching and detaching, respectively, with respect to said load-bearing structure; and
a latch connected to said ramp and movable between a first position and a second position with respect to said ramp;
wherein said latch automatically moves from said first position to said second position to trap said rod between said latch and said ramp when said ramp is moved toward said rod and said latch contacts said rod, thereby attaching said ramp with respect to said load bearing structure; and wherein said latch automatically moves from said second position to said first position to release said rod from between said latch and said ramp when said ramp is moved away from said rod, thereby detaching said ramp with respect to said load-bearing structure.

2. The load assembly of claim 1, further comprising:
a pivot pin disposable between said latch and said ramp for pivotably connecting said latch and said ramp with one another.

3. The loading assembly of claim 2, wherein said latch includes a first portion and a second portion, said first and second portions being angularly displaced from one another about said pivot pin such that said first portion contacts said rod causing said latch to pivot about said pivot pin to trap said rod between said second portion and said ramp when said ramp is moved toward said rod.

4. The loading assembly of claim 2, further comprising:
a spring element connected to said latch, wherein said latch is biased toward said first position by said spring element, said spring element acting to pivot said latch from said second position to said first position when said ramp is moved away from said rod.

5. The loading assembly of claim 1, wherein said load-bearing structure is a vehicle including a tailgate and a floor; wherein said tailgate and said floor at least partially define a cargo bed; and wherein said rod is connected to said tailgate.

6. The loading assembly of claim 5, wherein said tailgate is formed with a recessed portion, wherein said rod includes two end portions and a midportion between said end portions, wherein said rod is pivotably mountable to said tailgate at said two end portions, said rod being pivotable between a non-loading position, in which said rod is substantially within said recess, and a loading position, in which said midportion extends sufficiently from said tailgate such that said tailgate and said midportion form a gap therebetween, said latch being disposable within said gap such that said rod is trapped between said latch and said ramp when said ramp is moved toward said rod.

7. The loading assembly of claim 6, wherein said rod at least partially restrains movement of said ramp between said two end portions when said latch is disposed within said gap.

8. The loading assembly of claim 1, wherein said ramp is extendable between said load-bearing structure and a support surface; wherein said ramp includes a first end and an opposing second end; wherein said latch is connected to said ramp at said first end, and further comprising:
another latch substantially identical functionally and structurally with said first said latch; wherein said another latch is connected to said ramp at said second end;
wherein said first or second end of said ramp is selectively movable toward said rod such that said first said latch or said another latch, respectively, attaches said ramp with respect to said load bearing structure and the other of said another latch and said first said latch, respectively, extends between said ramp and said support surface, thereby effectively extending the length of said ramp.

9. A vehicle comprising:
a floor;
a tailgate pivotable between a substantially perpendicular and a substantially coplanar position with respect to said floor; wherein said floor and said tailgate are configured to at least partially define a cargo space;
a rod connected to said tailgate;
a ramp configured for loading said cargo space;
a latch connected to said ramp and pivotable between a first position and a second position with respect to said ramp;
a spring element connected to said latch, wherein said spring element biases said latch toward said first position;
wherein said ramp is selectively movable toward and away from said rod;
wherein said latch is configured to contact said rod when said ramp is moved toward said rod and said tailgate is in said substantially coplanar position, wherein said latch pivots from said first position to said second position to trap said rod between said latch and said ramp, thereby attaching said ramp with respect to said tailgate to permit loading of said cargo space; and
wherein said spring element causes said latch to pivot from said second position to said first position when said ramp is moved away from said tailgate, thereby releasing said rod from said latch to detach said ramp with respect to said tailgate.

10. The vehicle of claim 9, wherein the vehicle rests on a support surface, wherein said ramp has a first end and an opposing second end; wherein said latch is connected to said ramp at said first end and traps and releases said rod when said first end is moved toward and away from said rod, respectively, the vehicle further comprising:
another latch connected to said ramp at said second end, another spring element connected to said another latch, said another latch and said another spring element functioning identically as said first said latch and said first said spring element, respectively, such that said another latch traps and releases said rod when said second end is moved toward said rod and said another latch contacts said rod, and is moved away from said rod, respectively; and
wherein each of said first said latch and said another latch is configured to extend between said ramp and said support surface, thereby effectively extending said ramp, when the other of said first said latch and said another latch, respectively, traps said rod.

11. The vehicle of claim 10, wherein said ramp is configured with a generally elongated planar shape; and
wherein said floor is characterized by a first length;
wherein said ramp and said connected latch together are characterized by a second length that is shorter than said first length such that said ramp with said connected latches fits within said cargo space for storage when said ramp is detached with respect to said tailgate and said tailgate is in said substantially perpendicular position.

12. The vehicle of claim 9, further comprising:
a pivot pin mounted to said first said latch and pivotably connecting said latch and said ramp; and
wherein said latch includes a first portion and a second portion, said first and second portions being angularly displaced from one another about said pivot pin such that said first portion contacts said rod causing said latch to pivot about said pivot pin to trap said rod between said second portion and said ramp when said ramp is moved toward said rod.

13. The vehicle of claim 9, further comprising:
an additional ramp configured for loading said cargo space;
an additional latch connected to said additional ramp; and
an additional spring element connected to said additional latch;
said additional ramp, said additional latch and said additional spring element being substantially identical functionally and structurally with said first said ramp, said first said latch, and said first said spring element, respectively, such that both of said ramps are attachable with respect to said tailgate via said respective latches trapping said rod between said respective latches and said respective ramps to permit loading of said cargo space via both of said ramps.

14. A method comprising:
pivoting a tailgate connected to a floor of a vehicle from a closed position, in which said tailgate is substantially perpendicular to the floor, said tailgate and floor at least partially defining a cargo space, to an open position, in which said tailgate is substantially coplanar with respect to said floor for loading said cargo space;
moving a ramp toward a rod connected to said tailgate;
contacting a latch attached to said ramp with said rod, thereby at least partially supporting said ramp by said rod and causing automatic movement of said latch from a first position to a second position to trap said rod between said latch and said ramp to attach said ramp with respect to said tailgate.

15. The method of claim 14, further comprising:
moving said ramp away from said rod, thereby causing said latch to come out of contact with said rod and causing automatic movement of said latch from said second position to said first position to release said rod from between said latch and said ramp to detach said ramp with respect to said tailgate.

16. The method of claim 15, further comprising:
storing said ramp in said cargo space; and
pivoting said tailgate from said open position to said closed position to contain said ramp within said cargo space.

17. The method of claim 15, wherein said moving said latch from said first position to said second position and said moving said latch from said second position to said first position are via pivoting said latch.
